(19) United States
(12) Patent Application Publication
(10) Pub. No.: US 2016/0078071 A1
(43) Pub. Date: Mar. 17, 2016

(54) LARGE SCALE OFFLINE RETRIEVAL OF MACHINE OPERATIONAL INFORMATION

(71) Applicant: CATERPILLAR INC., PEORIA, IL (US)

(72) Inventor: Darin James McCOY, East Peoria, IL (US)

(73) Assignee: CATERPILLAR INC., Peoria, IL (US)

(21) Appl. No.: 14/483,443

(22) Filed: Sep. 11, 2014

(51) Int. Cl. G06F 17/30

(52) U.S. Cl. CPC G06F 17/30321

(57) ABSTRACT

A computer-implemented method of retrieving information stored on a computer readable storage medium and related to operation of a machine includes creating one or more lists of a plurality of data files stored on the computer readable storage medium and containing data derived from sensors measuring one or more machine operational characteristics. The method may further include creating one or more lists of a plurality of channels of information with signals indicative of the one or more machine operational characteristics recorded in each data file, creating an index of variables contained in one or more of the channels of information recorded in each data file, and searching for and locating data files that meet requestor-specified conditions by employing at least one of the lists of data files, at least one of the lists of channels of information, and the index of variables recorded in each data file to focus a search for relevant data files meeting the requestor-specified conditions.

### TECHNICAL FIELD

The present disclosure is directed to retrieval of machine operational information and, more particularly, to large scale offline retrieval of machine operational information.

### BACKGROUND

In recent years there have been significant advancements in sensor technology and in the computational ability to process large amounts of data generated by the improved sensors. This in turn has created a need to be able to sift through the sensor data to find information relevant to the diagnosis and correction of potential problems encountered in the operation of various machines. In the field of data analysis, various search tools have also been developed for finding and ranking datasets with associated metadata using user-entered parameters. Advances in data collection devices (i.e., deployed sensors that transmit data to a central point) have streamlined and automated tasks that once required manual attention, increasing the rate at which data is collected and analyzed. For example, terabytes of data relevant to the operation of earth moving machines have been accumulated from various fixed and mobile deployed sensors associated with the machines.

While this expansive collection of data provides researchers and other interested parties with a wealth of information, it has become increasingly time-consuming and difficult to find data relevant to determining the source of a particular problem, or useful in evaluating the results of additions or changes to various features on a machine. Locating and scanning each potentially relevant dataset (i.e., collection of related data points) not only requires time, but an understanding of each dataset's storage location, access methods, and format as well. Often, the user is unaware of or unable to identify relevant datasets. For example, datasets from a sensor that is stationary at a known location of interest, e.g., a pressure sensor at the inlet to an exhaust gas recirculation (EGR) system, or a fuel flow sensor at an inlet to a combustion chamber, must still be searched for the appropriate time interval during which information relevant to a particular condition occurred.

While many tools exist to analyze and/or visualize data, these tools must be told a dataset and data ranges to analyze/visualize. While such tools can help in identifying data that is potentially of interest, when large quantities of data are involved, the process of finding relevant data can be very time consuming. That is, existing tools do not address the problem of assisting with the discovery of datasets that have the potential to be relevant to a specific event or machine operating characteristics occurring at a particular time and/or place.

An exemplary method for monitoring the operating parameters of a complex system is disclosed in U.S. Pat. No. 6,732,063 (“the '063 patent”), issued May 4, 2004. The method taught in the '063 patent continually gathers data from a number of sources and generates alerts when certain normalized thresholds are exceeded.

While the method taught by the '063 patent may assist with the identification of abnormalities in a system as the system is being operated, the method does not address the problem of being able to locate and retrieve data meeting user-specified conditions from a large database after a particular abnormality in machine operations or other special condition occurred. The '063 patent discusses defining a window of samples over which data is to be analyzed, and introducing a weighting factor to define thresholds dependent on the performance of monitored components. However, the '063 patent still leaves room for improvement in the area of acquiring, identifying, and processing of information in a large database of machine operational parameters.

The exemplary embodiments of the present disclosure are directed toward overcoming one or more of the problems set forth above and/or other problems of the prior art.

### SUMMARY

In one aspect of the present disclosure, a method of retrieving information stored on a storage medium and related to the operation of a machine is described. The method may include creating one or more lists of a plurality of data files stored on the storage medium and containing data derived from sensors measuring one or more operational characteristics of the machine. The method may further include creating one or more lists of a plurality of channels of information with signals indicative of the machine operational characteristics recorded on each data file, and creating an index of a plurality of variables recorded in each data file. The method may still further include searching for and locating data files that meet user-specified conditions by employing at least one of the lists of data files, at least one of the lists of channels of information, and the index of a plurality of variables recorded in each data file to focus a search for relevant data files meeting the user-specified conditions.

In another aspect of the present disclosure, a system is described for acquiring and processing information stored in data files on at least one non-transitory computer readable storage medium, where the information is related to machine operational characteristics. The system may include one or more processors, and one or more non-transitory computer readable storage medium storing computer readable program code executable by the one or more processors. The computer readable program code may include a first crawler program configured to create a list of a plurality of data files stored on the at least one non-transitory computer readable storage medium and containing data derived from sensors measuring one or more operational characteristics of the machine. The first crawler program may also be configured to create a list of a plurality of channels of information with signals indicative of the one or more machine operational characteristics recorded in each data file, and identify and index variables recorded in each data file. The computer readable program code may also include a second crawler program configured to create metadata for a plurality of data files stored on the at least one non-transitory computer readable storage medium. The metadata indicates where the variables are located within each data file. An information retrieval module may be configured for receiving specified conditions related to operation of the machine and using the list of data files, the list of channels of information, the index of variables recorded in each data file and the metadata for a plurality of data files to find and return information relevant to the machine operational characteristics that meet the specified conditions.

In a further aspect of the present disclosure, a computer program product includes a non-transitory computer readable storage medium storing computer readable program code executable by one or more processors. The computer readable program code may be configured to create a list of a plurality of data files stored on at least one non-transitory computer readable storage medium and containing data derived from sensors measuring one or more operational characteristics of the machine. The code may also be configured to create a list of a plurality of channels of information with signals indicative of the one or more machine operational characteristics recorded in each data file, identify and index variables recorded in each data file, and create metadata for a plurality of data files stored on the at least one non-transitory computer readable storage medium. The metadata may indicate where the variables are located within each data file. The computer readable program code may also be configured to receive specified conditions related to operation of the machine and use the list of data files, the list of channels of information, the index of variables recorded in each data file and the metadata for a plurality of data files to find and return information relevant to the machine operational characteristics that meet the specified conditions.

### BRIEF DESCRIPTION OF THE DRAWINGS

FIG. 1 is a schematic illustration of one exemplary implementation of a system according to this disclosure.

FIG. 2 is a flow chart illustrating a method performed in accordance with an exemplary implementation of this disclosure.

FIG. 3 is a block diagram illustrating one exemplary implementation of a system according to this disclosure.

### DETAILED DESCRIPTION

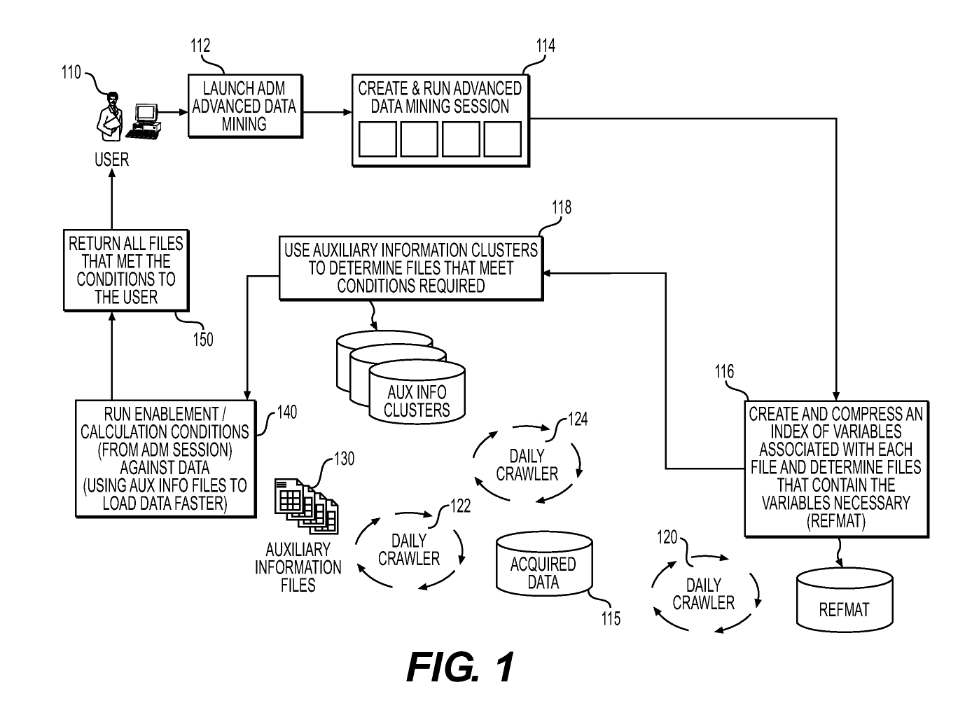

FIG. 1 illustrates an exemplary solution for identifying datasets of machine operational data that meet user-specified conditions through a data mining tool in accordance with various implementations of the present disclosure. Machine operational data can be data obtained from a large variety of sensors, as well as data calculated from other data obtained directly from the sensors. The data may be characterized as categorical data, or as actual numerical data. Categorical data refers to a mathematically expressible set of items having an order or structure, where a defined set can include/exclude subsets of the items. That is, categorical data can refer to a structure where defined subsets of enumerable items are contained within a larger set. Categorical data, for example, can have a hierarchical structure. For instance, a category of fuel flow data can include a plurality of more specific subsets of fuel flow data obtained at a particular combustion chamber, or fuel injector, and only during a particular defined time period. In some implementations of this disclosure the data files may be formatted in a binary data container format with a .mat extension (referred to herein as “MAT” files.) MAT files are categorized as data files that include variables, metadata, arrays and other information.

A user 110 may be able to launch an advanced data mining (ADM) process, as represented by “Launch ADM” 112 in FIG. 1, from any of a number of different terminals or computing platforms, including a personal computer, a smartphone, a laptop, a tablet computer, a mobile command center, and a terminal at a central command center. An advanced data mining (ADM) session represented by “Create & Run Advanced Data Mining Session” 114 in FIG. 1 then begins to scan terabytes of acquired data 115 that have already been accumulated in data files for particular conditions that can be used to improve quality or that may otherwise be useful for understanding or monitoring machine operating characteristics. The data files may be stored on any combination of one or more computer readable storage medium(s). A computer readable storage medium may be, for example, an electronic, magnetic, optical, electromagnetic, infrared, or semiconductor system, apparatus, or device, or any suitable combination of the foregoing. More specific examples of the computer readable storage medium may include a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. A computer readable storage medium may be any tangible medium that can contain, or store data and/or a program for use by or in connection with an instruction processing system, apparatus, or device. In various implementations according to this disclosure the ADM session may include processing of multiple data files stored on one or more computer readable storage medium in parallel in order to expedite the process. During a typical ADM session a plurality of crawler programs may process the terabytes of data recorded on one or more computer readable storage medium in order to organize and index the data files in ways that will expedite the retrieval of data meeting conditions specified by a user.

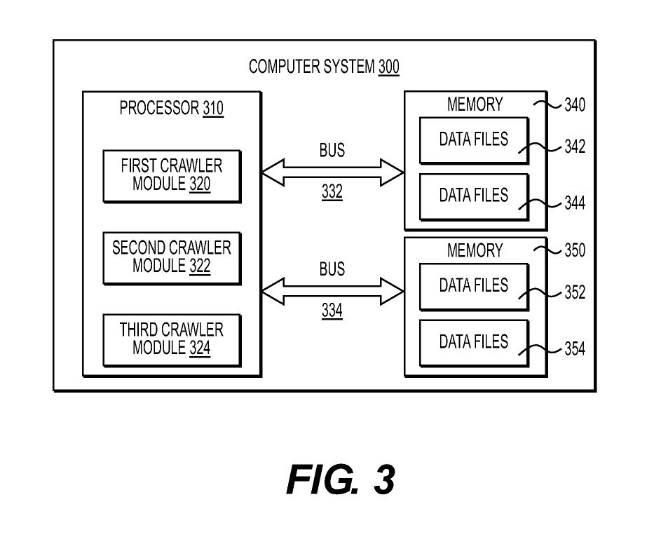

A system in accordance with various implementations of this disclosure may acquire and process information stored in data files on at least one non-transitory computer readable storage medium, where the information is related to machine operational characteristics. The system may include one or more processors and one or more non-transitory computer readable storage medium storing computer readable program code executable by the one or more processors. An exemplary computer system 300 is illustrated in FIG. 3, including a processor 310 and first and second memory devices 340 and 350. Although only one processor 310 is shown, multiple processors may also be provided, with one or more of the processors located on the same computing device or on different devices. Similarly, although a first memory device 340 and second memory device 350 are shown, fewer or additional memory devices may be included, with one or more of the memory devices located on the same computing device or at other locations accessible over various wired or wireless networks. Each of the memory devices 340, 350 may contain multiple data files, such as data files 342, 344, 352, 354. The processor 310 may include a plurality of modules that perform different functions in the processing of the information related to machine operational characteristics stored in the data files 342, 344, 352, and 354. As shown in FIG. 3, the one exemplary processor 310 may include a first crawler module 320, a second crawler module 322, and a third crawler module 324. Each of the crawler modules may access data files stored within at least one of the first and second memory devices 340, 350 over one or more buses such as bus 332 and bus 334. In alternative implementations, the crawler modules may access data files that are shared network data files located in one or more locations in proximity to or remote from the processor 310. In various implementations of this disclosure, one or more of the processors and the shared network data files may be accessible over wired or wireless networks, over cellular networks, over the Internet, or through other shared resources provided by different infrastructure providers.

The computer readable program code contained within the first crawler module 320 may include a first crawler program 120 configured to create a reference file having the .mat extension (referred to herein as a “REFMAT” file.) The first crawler program 120 may be configured to create the REFMAT file by generating a list of a plurality of data files on the computer readable storage medium containing information related to machine operational parameters. These data files may contain time series sensor data derived directly from a variety of sensors associated with a machine, or calculated from the sensor data in accordance with various algorithms or equations. Time series sensor data is sensor-generated data that may be constantly changing with the passage of time, for example, during the operation of a machine. Examples of the types of time series sensor data that may be recorded on the storage medium include, but are not limited to, engine speeds, intake manifold temperatures and pressures, EGR system temperatures and pressures, combustion chamber pressures and temperatures, fuel flow rates, electrical system characteristics including voltages, currents, power, frequencies, and amplitudes, emission system characteristics, including levels of particulates and quantities of various emissions such as Nitric Oxide (NO), and other machine operational parameters and characteristics.

The first crawler program 120 may also be configured to create a list of a plurality of channels of information that are recorded on the data files. A channel of information includes signals indicative of the machine operational characteristics over a period of time. The signals that may have been recorded on any particular data file include signals indicative of sensor-measured values and calculated values derived from one or more sensor-measured values. Additional channels of information may be created in any particular ADM session 114, in accordance with user-specified conditions, by including new algorithms or additional calculations to create additional signals indicative of new calculated values to be derived from one or more sensor-measured values. The first crawler program 120 may be further configured to identify the features and variables recorded on each data file, and cross reference similar types of information or associated information from the other data files. As shown in FIG. 1, box 116, the first crawler program 120 may run on a daily basis or at other desired time intervals to process the acquired data 115 stored on computer readable storage medium. The first crawler program 120 may create and compress an index of a plurality of the identified variables associated with each of the data files, and then determine which of the data files contains the variables that meet the conditions specified by a user.

Computer readable program code contained within the second crawler module 322 may include a second crawler program 122 configured to generate auxiliary information files 130 by creating metadata for a plurality of data files contained in the acquired data 115. The metadata is data that describes or characterizes the data recorded on the data files in a way that will allow for rapid location and retrieval of specific data that meets conditions specified by a user. A few examples of the types of metadata that may be created by the second crawler program 122 include serial numbers, part numbers, and/or model numbers associated with a machine from which the data was collected, a particular bore size of the cylinders in an engine from which data was collected, and the particular type of fuel injection being used in the engine from which data was collected.

Regardless of the type of machine operational data being searched, the auxiliary information files 130 are data files provided with associated metadata by the second crawler program 122, with the metadata providing a way in which to summarize sets of the data. The metadata can define searchable parameters, which can represent significant characteristics of a larger set of underlying data. Thus, the metadata can be searched, instead of the underlying data, which determines (with a high probability) whether a larger set of items satisfy search criteria or not. This approach of using auxiliary information files when retrieving data files that meet conditions specified by a user is significantly more resource efficient than having to search the underlying data of the entire data set.

In one or more implementations of this disclosure, computer readable program code may also be provided in the third crawler module 324 to include a third crawler program 124. The third crawler program 124 may be configured to drill down and further narrow the amount of recorded data that is of interest when meeting conditions specified by a user. The third crawler program 124 may be configured to identify minimums, maximums, or ranges of data included within a broader set of data recorded from each channel of information. When the user 110 launches an advanced data mining session 112, a multi-stage search can be conducted. In an initial stage of the advanced data mining session 114 a reduced data set may be generated from the set of data files constituting the acquired data 115 recorded on the computer readable storage medium. The reduced data set may include those items having metadata satisfying user-specified constraints, such as items found within auxiliary information files 130. In a second stage, the underlying data of the reduced data set can be searched in accordance with further created enablement conditions that define additional user-specified constraints. The enablement conditions defining additional user-specified constraints can be paired with the creation of additional calculation channels, as discussed above, to create additional signals indicative of new calculated values to be derived from one or more sensor-measured values. As shown at box 140 in FIG. 1, the enablement conditions and calculation conditions may be run during an ADM session while using the auxiliary information files in order to load data faster and provide a focused search for data meeting requestor-specified conditions. Since each metadata value corresponds to a larger set of underlying data values, significantly fewer items have to be searched to achieve the ultimate result. For instance, the reduced data set can include data items gathered within a specific date range, within a specific time period, and/or belonging to a specific category of time series sensor data, such as only temperatures and/or pressures that exceed a predetermined minimum threshold. These reduced data sets may be represented as auxiliary information clusters 118, shown in FIG. 1. The reduced data set can represent a more manageable quantity of data items, which can be reasonably searched, where a high probability (or at least a statistically reasonable probability) exists that the desired data items per the search parameters are included in the reduced data set. This high probability that the desired data items are present in the reduced data set is dependent on inherent characteristics of the data that facilitates grouping. For example, numerical values can be easily grouped within a range, where the metadata can specify that specific range. Similarly, categorical data can be grouped according to definable categories (i.e., the parent set of data items can be decomposed into a plurality of meaningful subsets of data items, each of which include multiple data items).

Machine operational data may be gathered by various types of mechanical, electrical, and chemical sensors, which indicate values of one or more conditions proximate to the sensor at a given date and time, and in some implementations, only when other conditions are met such as the ignition of a machine is turned on. Important metadata of the underlying data sets often includes identification information such as a serial number of the machine on which the sensor is located, and temporal data that represents when the sensor readings are obtained. Other data is often dependent on the type of sensor and readings being obtained. For example, if the sensor is deployed in an intake manifold of an engine, relevant numerical data (for incorporation into the metadata) may include a range of pressures and/or temperatures, and/or flow rates in the intake manifold where the sensor is located. Relevant categorical data may include engine serial numbers, machine make and model numbers, the year in which the machine was manufactured, the number of miles or hours of operation of the machine, or other information that will help to focus a search for certain user-specified conditions. In addition to the raw data gathered directly from various sensors mounted on or in proximity to a machine, other data may be generated by scientific models that simulate systems being observed, or algorithms that calculate parameters based on engineering principles.

Searching the large quantities of measured and calculated data that can be gathered and stored over a period of time during operation of a machine can be very time consuming and impractical. That is, crawling inclusive data in a single dimension (that is not pre-indexed or summarized) can take too long to provide a practical way of improving quality or diagnosing problems that may occur during machine operation. Performing significant searches against entire ranges of information acquired in multiple dimensions and time periods without any defined constraints can be even more difficult. This is especially true when combining data from a large set of sensors to track real world phenomena. The problem is often referred to as data overload, which comes from an increasingly large set of deployed sensors and monitoring applications, which produce streaming data that is live, continuously changing, and voluminous. The problem is not a lack of data, but in not being able to intelligently consume and digest the importance expressed by this data. This type of streaming or generated data, referred to herein as time series sensor data is fundamentally different from traditional captured data sets in many important ways, which make digesting this information problematic, thereby leading to the data overload problems. When working with time series sensor data, new streaming data is constantly being loaded and stored on the computer readable storage medium. In other words, there are no updates, only inserts (in huge quantities) to the data set. Data that was measured or calculated at any particular point in time must be retained as originally recorded in order to provide an accurate record of what actually was occurring at that time. Next, analytics of time series sensor data is preferably performed in or close to the underlying database programmatically as the database continues to grow rather than relying on ad hoc queries (e.g., standard structure query language (SQL) queries) and other existing tools.

An ad hoc query is a query that cannot be determined prior to the moment the query is issued. It is created in order to get information when a need arises and it consists of dynamically constructed SQL which is usually constructed by desktop-resident query tools. This is in contrast o any query which is predefined and performed routinely, or which is performed in or close to an underlying database or other source of data flies programmatically, as when analyzing very large quantities of time series sensor data that is being constantly added to a computer readable storage medium. An ad hoc query does not reside in the computer or the database manager but is dynamically created depending on the needs of the data user. In the past, for users to analyze various kinds of data, multiple sets of queries may have been constructed. These queries may have been predefined under the management of a database or system administrator and so a barrier between the users' needs and the canned information may have existed. As a result, the end user may get a bombardment of unrelated data in the query results. The IT resources employed in responding to these ad hoc queries may also get a heavy toll since a user may have to execute several different queries at any given period. As discussed above, advancements in sensor technology and in the computational ability to process large amounts of data generated by the improved sensors has created a need to be able to rapidly sift through the sensor data that has been acquired and recorded up to a particular point in time to find information relevant to the diagnosis and correction of potential problems encountered at some earlier time in the operation of various machines. This has also created a need to accelerate retrieval of vital information from various computer readable storage medium to quickly answer interactive queries in mission critical situations. Ad hoc query tools may also have a heavy resource impact depending on the number of variables needed to be answered. To reduce impact on memory due to usage of ad hoc queries, the computer must have huge amount of memory, provide very fast devices to be used as temporary disk storage, and the database manager must prevent very high memory usage ad hoc queries from being executed. Some database managers anticipate huge sort requirements by having exact match pre-calculated results sets. But in a general ad hoc environment, a user is discouraged from issuing an ad hoc query to produce a report based on millions of transactions from the last years. Instead, users may choose data from a given range. Because of the high potential of performance degradation when a complex ad hoc query is executed, database managers sometimes only provide copy of the live database to he regularly refreshed. This in turn may also result in the failure of an ad hoc query to retrieve data that is most relevant for improving quality or diagnosing a cause for a problem encountered when operating the machine.

This disclosure provides a solution where the time series sensor data indicative of machine operational characteristics is indexed (and/or summarized) within metadata using one or more crawler programs that are able to continuously or intermittently process multiple data files in parallel. This metadata is compared during a search against a set of user-entered parameters. As discussed above, the metadata may be hierarchical in nature such that in some implementations a higher level of metadata, such as data that falls under a particular category, or numerical data within a broad range of values is searched. In other implementations only more narrowly defined auxiliary information clusters may be included in the search. The auxiliary information clusters may be constructed as a composite of the data that meets certain minimum values, maximum values, or ranges of values for certain defined and indexed variables contained within the recorded data files. One non-limiting example of an auxiliary information cluster could be recorded signals containing engine rpm's for engines having one of three different serial numbers, only during a particular time period, and only if those signals indicate an engine rpm that is greater than a certain minimum threshold. Upon receipt of user-entered search parameters, a dataset search tool can identify metadata records that are close to the user-entered search parameters. In one exemplary implementation, the user-entered search parameters can represent soft boundaries, which can be exceeded. A proximity score may be calculated for each metadata record to numerically express the proximity of the metadata record to the user-entered parameters. The identified metadata records can then be arranged by their proximity scores, in descending order, and presented to the user. In one embodiment, the proximity scores can be used for filtering records (as opposed to or in addition to being used for sorting/ranking purposes.) The ADM session initiated by a user in an effort to identify and retrieve the information that is most relevant to the conditions specified by the user may include implementation of one or more of the above-described crawler programs configured to create and compress an index of the variables in the data files, associate metadata with the data files in auxiliary information files, and create auxiliary information clusters of more narrowly defined subsets of the data.

The computer readable program code included in various implementations of this disclosure may further include an information retrieval module configured for receiving specified conditions related to operation of the machine. The information retrieval module may use the list of data files, the list of channels of information, the index of variables recorded in each data file and the metadata for a plurality of data files to find and return information relevant to the machine operational characteristics that meet the specified conditions. When data files have been identified that meet all of the conditions specified by a user or other requestor (such as an automated program that periodically requests data meeting specified conditions), the identified data files may be returned to the user or other requestor at block 150 in FIG. 1.

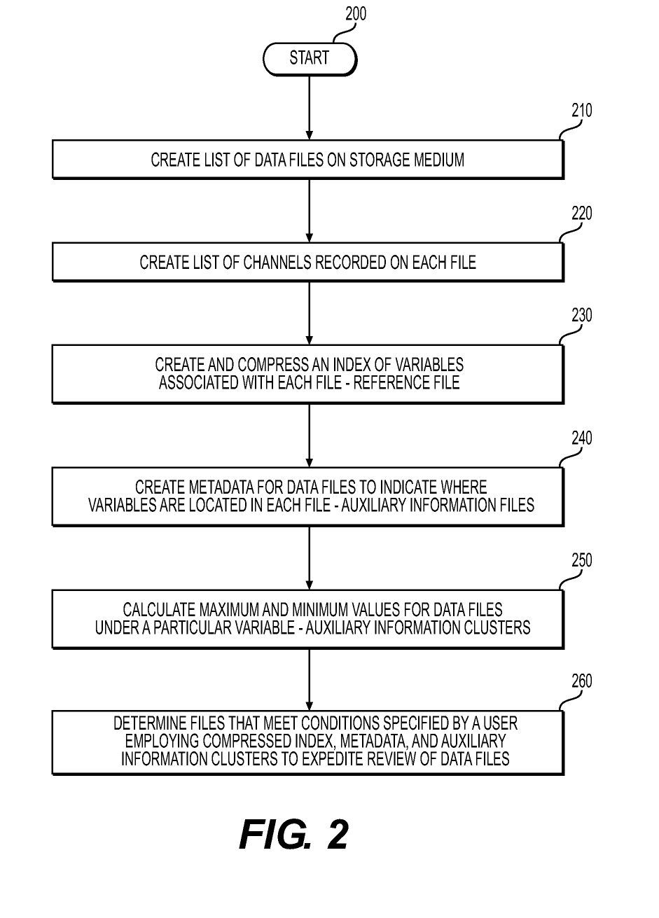

FIG. 2 illustrates an exemplary method of implementing expedited retrieval of machine operational characteristics from a database recorded on computer readable storage medium, as set forth in more detail in the following section.

### INDUSTRIAL APPLICABILITY

A data mining method and system in accordance with this disclosure allows a user to quickly identify and investigate data associated with past occurrences in the operation of a machine under certain specified conditions as a result of the categorization and indexing of a plurality of the variables contained within large numbers of data files. A system in accordance with various implementations of this disclosure may receive instructions from a user with regard to the specific conditions that are suspected to have led to a particular incident or modification in customer behavior. The system retrieves relevant data files quickly by employing the compressed index, metadata, and auxiliary information clusters already created by one or more crawler programs.

In an exemplary implementation of a method performed by a system according to this disclosure, a first crawler program utilized during an ADM session may initiate an ADM session at step 200, and create a list of a plurality of data files recorded on the computer readable storage medium at step 210. The first crawler program may process multiple data files recorded on one or more computer readable storage medium in parallel in order to expedite the process. The first crawler program may also create a list of a plurality of channels of information that are recorded on each of the data files at step 220. A channel of information may include signals indicative of the machine operational characteristics over a period of time. The signals of a channel of information recorded on any particular data file may include signals indicative of sensor-measured values, as well as calculated values derived from one or more sensor-measured values.

The first crawler program may also identify a plurality of the various features and variables recorded on each of the data files, and then create and compress an index of the variables associated with each data file at step 230. The resulting reference file, referred to herein as a REFMAT file, may use the index to cross reference similar types of information recorded on some or all of the data files with other data files containing the same types of information.

A second crawler program may create metadata for a plurality of recorded data files to indicate where a plurality of the variables are located in each of the data files at step 240, thereby creating auxiliary information files. These auxiliary information files may be hierarchical in nature, with some metadata describing high level categorical classifications of the types of data, or broad ranges of numerical values encompassing the data. Other metadata may describe lower level subsets of information included within the higher level classifications.

A third crawler program may drill down even deeper into more specific classifications of the recorded data, calculating maximum values, minimum values, or ranges of values for all of the data files under a particular variable at step 250. These more specific classifications of data that fall below designated maximum values, above designated minimum values, or within designated ranges of values may be organized into auxiliary information clusters.

The result of continuously or intermittently running the various crawler programs on the data files as data is added to the data files is to allow for the determination and rapid retrieval of files that meet conditions specified by a requestor. The rapid retrieval of data meeting the specified conditions is achieved by employing one or more of the compressed index, metadata, and auxiliary information clusters to expedite review of the data files at step 260. In certain implementations of this disclosure the files that have been determined to meet the conditions specified by a user may be returned to the user in the form of a report or tabulation of data. In some implementations this information may be used by simulation playback software if desired to attempt to recreate the conditions that were present at the time of or leading up to a past occurrence. New designs or variations to existing designs may be implemented under the same conditions that existed at the time of the past occurrence in order to attempt to improve results or avoid undesirable results. Changes in customer behavior may also be investigated in conjunction with the implementation of design changes or the addition of new features.

It will be apparent to those skilled in the art that various modifications and variations can be made to the methods and system of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. A computer-implemented method of retrieving information stored on a computer readable storage medium and related to operation of a machine, the method comprising:
creating one or more lists of a plurality of data files stored on the computer readable storage medium and containing data derived from sensors measuring one or more machine operational characteristics;
creating one or more lists of a plurality of channels of information with signals indicative of the one or more machine operational characteristics recorded in each data file;
creating an index of a plurality of variables contained in one or more of the channels of information recorded in each data file; and
searching for and locating data files that meet requestor-specified conditions by employing at least one of the lists of data files, at least one of the lists of channels of information, and the index of a plurality of variables recorded in each data file to focus a search for relevant data files meeting the requestor-specified conditions.

2. The method of claim 1, further including creating metadata for a plurality of data files, wherein the metadata specifies where a plurality of the variables are located in each data file.

3. The method of claim 1, further including calculating one or more of a maximum value, a minimum value, or a range of values for a particular variable recorded in at least one of the data files.

4. The method of claim 2, further including calculating one or more of a maximum value, a minimum value, or a range of values for a particular variable recorded in at least one of the data files.

5. The method of claim 1, wherein each of the channels of information includes at least one of a sensor-measured value and a calculated value derived from at least one sensor-measured value.

6. The method of claim 5, wherein the at least one sensor-measured value is time series sensor data that is one of periodically or continuously added to the at least one of the data files.

7. The method of claim 1, wherein the variables recorded in each data file include one or more characteristics associated with the machine or with operation of the machine, the one or more characteristics including at least one of an identifying characteristic of the machine, a value measured by a sensor during operation of the machine, and a calculated value derived from at least one value measured by a sensor during operation of the machine.

8. The method of claim 1, wherein the creating of one or more lists of a plurality of data files stored on the computer readable storage medium is performed by a crawler program that processes a plurality of the data files stored on the computer readable storage medium in parallel to identify data files containing data that is either derived directly from the sensors or is calculated from data derived directly from the sensors, and that cross-references data on identified data files with similar types of data contained on other data files.

9. The method of claim 8, wherein the crawler program also creates the one or more lists of a plurality of channels of information and creates the index of a plurality of variables recorded in each data file.

10. A system for acquiring and processing information stored in data files on at least one non-transitory computer readable storage medium, the information being related to machine operational characteristics, the system comprising:
one or more processors;
one or more non-transitory computer readable storage medium storing computer readable program code executable by the one or more processors, the computer readable program code comprising:
a first crawler program configured to:
create a list of a plurality of data files stored on the at least one non-transitory computer readable storage medium and containing data derived from sensors measuring one or more operational characteristics of the machine;
create a list of a plurality of channels of information with signals indicative of the one or more machine operational characteristics recorded in each data file; and
identify and index variables recorded in each data file;
a second crawler program configured to:
create metadata for a plurality of data files stored on the at least one non-transitory computer readable storage medium, wherein the metadata indicates where the variables are located within each data file; and
an information retrieval module configured for receiving specified conditions related to operation of the machine and using the list of data files, the list of channels of information, the index of variables recorded in each data file and the metadata for a plurality of data files to find and return information relevant to the machine operational characteristics that meet the specified conditions.

11. The system of claim 10, wherein the computer readable program code further includes a third crawler program configured to calculate one or more of a maximum value, a minimum value, or a range of values for a particular variable recorded in at least one of the data files.

12. The system of claim 10, further including:
the first crawler program being further configured to create a list of a plurality of channels of information with signals indicative of the one or more machine operational characteristics recorded in each data file wherein each of the channels of information includes at least one of a sensor-measured value and a calculated value derived from at least one sensor-measured value.

13. The system of claim 12, wherein the at least one sensor-measured value is time series sensor data that is one of periodically or continuously added to one or more of the data files.

14. The system of claim 10, wherein the variables recorded in each data file include one or more characteristics associated with the machine or with operation of the machine, the one or more characteristics including at least one of an identifying characteristic of the machine, a value measured by a sensor during operation of the machine, and a calculated value derived from at least one value measured by a sensor during operation of the machine.

15. The system of claim 11, further including:
the first crawler program being further configured to create a list of a plurality of channels of information with signals indicative of the one or more machine operational characteristics recorded in each data file wherein each of the channels of information includes at least one of a sensor-measured value and a calculated value derived from at least one sensor-measured value.

16. The system of claim 14, wherein the at least one sensor-measured value is time series sensor data that is one of periodically or continuously added to one or more of the data files.

17. A computer program product comprising: a non-transitory computer readable storage medium storing computer readable program code executable by one or more processors, the computer readable program code being configured to:
create a list of a plurality of data files stored on at least one non-transitory computer readable storage medium and containing data derived from sensors measuring one or more operational characteristics of the machine;
create a list of a plurality of channels of information with signals indicative of the one or more machine operational characteristics recorded in each data file;
identify and index variables recorded in each data file;
create metadata for a plurality of data files stored on the at least one non-transitory computer readable storage medium, wherein the metadata indicates where the variables are located within each data file; and
receive specified conditions related to operation of the machine and use the list of data files, the list of channels of information, the index of variables recorded in each data file and the metadata for a plurality of data files to find and return information relevant to the machine operational characteristics that meet the specified conditions.

18. The computer program product of claim 17, further including:
computer readable program code configured to calculate one or more of a maximum value, a minimum value, or a range of values for a particular variable recorded in at least one of the data files.

19. The computer program product of claim 17, further including:
computer readable program code configured to create a list of a plurality of channels of information with signals indicative of the one or more machine operational characteristics recorded in each data file wherein each of the channels of information includes at least one of a sensor-measured value and a calculated value derived from at least one sensor-measured value.

20. The computer program product of claim 17, wherein the at least one sensor-measured value is time series sensor data that is one of periodically or continuously added to one or more of the data files.
